(19) United States
(12) Patent Application Publication
(10) Pub. No.: US 2005/0087317 A1
(43) Pub. Date: Apr. 28, 2005

(54) Dispersable wet wipe

(75) Inventor: Theodore B. Rydell, Pound, WI (US)

Correspondence Address: GODFREY & KAHN S.C., 780 NORTH WATER STREET, MILWAUKEE, WI, 53202, US

(73) Assignee: Little Rapids Corporation

(21) Appl. No.: 10/696,540

(22) Filed: Oct. 28, 2003

(51) Int. Cl. D21H 17/00; A01N 25/34; B31F 1/12

(52) U.S. Cl. 162/158; 162/111; 162/117; 424/402

(57) ABSTRACT

A readily dispersable wet wipe for cleaning surfaces is comprised of cellulosic fibers and produced on conventional papermaking equipment. The wet wipe substrate is preferably creped or embossed, and has a minimum basis weight of about 40 gsm. Depending on the intended end use, solutions used to wet the substrate may comprise at least 35 percent alcohol. Wet wipe substrates wetted with solutions of less than 35 percent alcohol contain a wet strength additive such as polyamide.

### BACKGROUND OF THE INVENTION

This invention relates to a pre-moistened wipe that is readily water dispersable and capable of being disposed of in a residential system for the disposal of liquid and semi-liquid waste.

Dispersability is a characteristic that is viewed as an important distinction from prior art wet wipes. A dispersable wipe is more than just “flushable.” Whereas dispersable wipes actually break up into small bits and individual fibers, flushable wipes do not necessarily break up at all. Therefore, flushability is a relatively low standard and only indicates that an item is small enough to be flushed down a toilet. Likewise, dispersability does not necessarily coincide with biodegradability.

Typically, individual wiping sheets are saturated with a chemical solution or “wetting solution” suited for an intended end use, then stacked and wrapped in a liquid tight package for subsequent dispensing. The wetting solution often includes bactericides and other biological control agents, as well as perfumes and the like. The liquid tight packaging maintains the saturated condition of the wiping sheet until use.

Such pre-moistened wipes, or simply, wipes, are commonly used by consumers for cleaning. As will be appreciated, it is often desirable to dispose of used pre-moistened wipes through a sewer or septic system. While pre-moistened wipes must have sufficient strength to resist tearing and puncturing during vigorous use, they also must easily and readily break up into smaller pieces within the moving water present in a sanitary or septic system, and preferably be substantially biodegradable. Therefore, a high wet tensile strength is very desirable, for resisting tears or punctures of the pre-moistened wipe during dispensing and use; however, the tensile strength cannot be so high as to prevent or unduly retard dispersion of the wipe. There is a delicate balance between strength and dispersion, which is affected by several variables, including the type of wetting solution in which the wipe is stored.

Disposable wet wipes of the type commonly distributed with messy foods such as barbecue ribs have been available for years. Comprised of conventionally-made paper containing relatively large amounts of wet strength additives, these wipes are relatively strong and are used to clean anything from hands to telephones. However, these wipes are not readily dispersable, and could cause plumbing problems if disposed of in conventional plumbing systems.

In more recent years, disposable wipes have been made for purposes other than cleaning sticky fingers, and have been made to be flushed down toilets. Typically, the webs from which these “flushable” wet wipes are made relatively thick and have a cloth-like feel. Such wipes may require a binder in order to provide strength to the web when it is wet. For example, U.S. patent application Ser. No. 09/934,867 to Goldstein, discloses a flushable wet wipe comprising a nonwoven web of fibers bonded with a water-soluble polymeric binder and an aqueous lotion. The binder may comprise either a polyvinyl alcohol (PVOH), an aqueous PVOH-stabilized polymer emulsion, a blend of a PVOH and an aqueous polymer emulsion, or a combination thereof. The aqueous lotion composition contains one or more compounds which “tie up” or bind the water in the aqueous lotion, so that the water does not substantially dissolve the nonwoven binder and cause premature dispersability of the web. One disadvantage of this invention is that it is made with a nonwoven substrate. Such substrates have poor hydrogen bonds and require chemical binders to create enough strength for practical use. In addition, the substance is costlier and introduces more chemicals into the wipe than is desirable.

In addition, Patent Application WO 02/22352 for applicant Ahlstrom Dexter LLC, and U.S. Pat. No. 5,292,581 to Viazmensky, et al., discloses another hydroentangled wet wipe, comprised of synthetic and natural fibers, and either synthetic binder fibers or wet strength additives, respectively. One disadvantage of these wet wipes is that the hydroentagling is relatively expensive. Another disadvantage relating to the Ahlstrom Dexler application is that the synthetic fibers require additional processing, and as a result, are expensive.

Accordingly, there is a well established need for a wet wipe that is absorbent, strong enough for hard surface cleaning, disperses easily in household plumbing, and is cost-effective to manufacture. Preferably, this wipe is biodegradable so that it is safe for septic systems, and uses relatively few chemicals in the wetting solution.

### BRIEF SUMMARY OF THE INVENTION

The present invention relates generally to a paper sheet material or substrate having sufficient wet strength to be used as a pre-moistened wipe or “wet wipe.” The substrate is capable of dispersing into small pieces and individual fibers with mild agitation in moving water after a brief period of time. The substrate is suitable for disposal in a sanitary waste system.

Specifically, the present invention provides a fibrous paper material that overcomes the above and other related previous problems in the art, and yet achieves good wet strength, handling and absorption characteristics. The invention is the result of experimentation directed toward finding the delicate balance between the strength needed for cleaning, and the weakness needed for dispersion. Though the sheet from which the wipes are made is conventionally-made paper, the primary variables influencing strength and dispersability have been selected to achieve surprising results.

The inventive sheet material's ability to breakup under mild agitation in water is a function of the sheet material's fiber composition and processing, as well as the type of solution that is applied to the sheet for cleaning, or even sterilizing surfaces. The inventive sheet material is comprised substantially of cellulosic materials so that it is suited for disposal in conventional sanitary systems.

The present invention provides a pre-moistened wipe having the following advantages: good tensile strength in a cleaning solution, good dry tensile strength required for manufacturing, and rapid dispersal of the disposed, used wipe under the ambient conditions of typical water-containing toilets.

One aspect of the invention provides a pre-moistened wet wipe made from a paper substrate of fibrillated cellulosic fibers. The substrate is moistened with a wetting solution comprising water and alcohol. The substrate, when wetted with the wetting solution, has a wet tensile strength of no less than 30 N/m and is dispersable within 50 shakes when tested using the mason jar shake test described herein.

In another aspect of the invention, the paper substrate has a basis weight of 40 to 75 gsm, and is composed of fibrillated wood fiber and up to 0.1% of a wet strength additive. The wetting solution is water-based, and may contain 0% to 35% alcohol. The wet wipe has a wet tensile strength of no less than 30 N/m and is dispersable when immersed and agitated in a solution of at least 99% water.

In a further aspect of the invention, the paper substrate has a basis weight of greater than 40 gsm, and a dry tensile strength of at least 1000 N/m. The wetting solution is 35% to 70% alcohol. The wet wipe has tensile strength of at least 30 N/m when wetted with the wetting solution, and is dispersable when agitated in a solution of at least 99% water.

In a further aspect of the invention, the paper substrate has a basis weight of about 47 gsm and has a dry tensile strength of about 200 N/m. The wetting solution is about 70% alcohol or greater. The wet wipe has wet tensile strength of at least 30 N/m when wetted with the alcohol-based wetting solution, and is dispersable when agitated in a solution of at least 99% water.

In yet another aspect of the invention, provided is a method of cleaning a toilet seat in a public bathroom. The method includes mounting a dispenser in a bathroom, removing a wet wipe from the dispenser, applying the wet wipe to the toilet seat, wiping the toilet seat with the wet wipe, and disposing of the wet wipe in the toilet bowl.

While one possible application of the present invention is in connection with cleaning hard bathroom surfaces, other applications are possible and references to use in connection with bathroom cleaning should not be deemed to limit the uses of the present invention. For instance, the wipes of the present invention may be used for camping or personal care in hospitals and the like, especially when it is desirable to dispose of the wipe by flushing it down the toilet. These and other objects and advantages of the present invention will become apparent from the detailed description and claims.

### DETAILED DESCRIPTION OF THE INVENTION

The wet wipe of the present invention is simplistic in one sense because it is made from paper and is relatively inexpensive to manufacture, yet rather sophisticated in another sense because it readily disperses and finally biodegrades in appropriate environments. The term “wet wipe” for purposes of the present invention means a web of fibers pre-moistened with a solution for cleaning or applying a solution to a surface. The term “dispersable” is defined as the ability of the wet wipe to break apart into small pieces in water or other aqueous solutions.

A strength property that is useful in partly quantifying the quality, usability and dispersability of the wipe is tensile strength. Tensile strength is measured herein according to Tappi Standard, reference method T404. Tensile strength may be measured in both the machine and cross directions. Machine direction is defined as the direction in which the substrate moves through the manufacturing machine. Cross direction is defined as the direction perpendicular to the machine direction. Typically, the cross direction is the weakest direction; it is in this direction that the first tears will occur when the wipe is subject to dispersability testing.

The tensile strength of a wet wipe is significantly affected by the liquid in which it comes into contact, and in particular, the ability of the liquid to disrupt the hydrogen bonds formed in the web from which the wipes are made. For example, it has been found that certain alcohol concentrations do not significantly disrupt the hydrogen bonds, so alcohol solutions are desirable as wetting solutions.

The preferred embodiment of the wet wipe of the present invention comprises a substrate which has a tensile strength in its weakest direction that is adequate for the wet wipe to be used for cleaning hard surfaces, such as a toilet. In the preferred embodiment, the wet tensile strength of the substrate in the weakest direction (likely the cross direction) is preferably at least 30 N/m when wetted with a 35% alcohol solution. In the most preferred embodiment, this wet tensile strength is about 100 N/m when wetted with the 35% alcohol solution.

The substrate may be designed such that the machine-direction tensile strength is higher than the cross-direction tensile strength. This design takes into account the additional tension that is placed on the wipe during dispensing of the individual wipe. Depending on the minimum tensile strength of the wipe, the wet wipes of the present invention may be dispensed from most any package such as a peel-open package, a pull-through package or a dispenser having a flip-top. Higher tensile strength wipes are needed to withstand most pull-through type packaging.

The wet wipe substrate of the present invention is capable of dispersing in water within a relatively short period of time, similar to how common toilet paper disperses. Dispersability is measured according to the “mason jar shake test” described herein.

Uses for the wet wipe of the present invention include cleaning of persons or hard surfaces. For example, persons may use the wipes to clean toilets in the household. Hospital personnel may use the wet wipes to clean toilets or other items in a hospital room. One particular yet non-limiting use is to place a dispenser containing the wet wipes in toilet stalls of public bathrooms. Visitors may use the wet wipes to clean the public toilet seat prior to use to ensure cleanliness.

Details regarding the wet wipe substrate and wetting solution are described more fully below. This information is followed by experimental data and suggested non-limiting embodiments of the present invention.

Substrate

The substrate is preferably provided by a web, and typically as a sheet of material cut from the web. Various embodiments of the web, to provide a substrate, are within the scope of the present invention. The web is laid on conventional paper-making equipment and may be comprised of natural fibers such as wood, cotton, grasses, sisal, hemp, and kenaf fibers. In a preferred embodiment, the wet wipe comprises 100% wood pulp fibers from conventional sources. Such fibers may be chemically pulped, unbleached or bleached, virgin or recycled, hardwood or softwood fibers. Preferably, the fibers are obtained from softwood species harvested from northern climates (e.g., Wisconsin, Minn., Canada) because such woods typically have a higher number of fibers per gram than hard woods or woods from other climates. In the most preferred embodiment, a pulp containing primarily northern kraft softwood is used, such as Weyerhaeuser “Grande Prairie Softwood” bleached kraft. This fiber has the characteristic of being relatively thin-walled and flexible.

In addition to the fibers used to make the web, the web can comprise other components or materials added thereto as known in the art, to improve appearance, surface texture, color, and odor. One example is the use of opacifying agents.

Preferably, in order to achieve adequate strength of the wet wipe substrate, the fibers are refined by external fibrillation. External fibrillation is a process whereby fibers of the web are beaten by means of mechanical or other forces. On a macroscopic level, this beating loosens the microfibrils on the fiber surface. The microfibrils become raised, giving the surface a somewhat hairy appearance and thereby increasing the surface area of the fibers. On a microscopic level, refining fiber in the presence of water essentially “pops apart” the cellulose microfibrils to expose rows of hydroxyl (OH) groups. Any one of the hydroxyl groups has the capacity to form a hydrogen bond. When two or more microfibrils come in close contact during the web drying process, fiber-to-fiber hydrogen bonds are developed. This happens when an oxygen atom pulls electron density away from an adjacent hydrogen. The result is analogous to VELCRO®, wherein the hook and loop members are oxygen and hydrogen atoms. While this process was first thought to be reversible (that dried sheets when fully rewetted will “redisperse” back into individual fibers) tests have shown that certain species develop strong hydrogen bonds when refined, wet formed, and dried into a web having sufficient basis weight (40 to 100 grams per square meter). Such sheets can be rewetted with water-based wetting solutions in pH ranges of 4 to 10, and yet maintain adequate wet tensile strength without additive chemistries such as wet strength cross-linking agents.

The experimental data included herein shows that fibrillation improves fiber bonding to the point where it negatively affects dispersability. Therefore, a balance between the amount of fibrillation, basis weight, and wetting solution composition is a consideration for webs made from any particular fiber type.

The substrate or web is preferably formed using conventional papermaking techniques. In these techniques the fibrillated fibers are dispersed in a suitable liquid dispersing media to create a furnish. Preferably, the liquid media is water in accordance with known papermaking techniques. Accordingly, a furnish comprising water, natural cellulose fibers and other additives is formed. The total concentration of fibers in the furnish will be a function of the equipment used and desired equipment processing parameters.

For wipes that are wetted with solutions containing less than about 35% alcohol, it is desirable to incorporate a conventional wet strength agent into the furnish as an additive. Conventional wet strength agents such as polyamide- or formaldehyde based agents may be used, with the most preferred agent being polyamide. Other wet strength agents include urea-formaldehyde resins and polyamide-epichlorohydrin resins. Preferably, less than about 0.1% wet strength is added to the sheet, and most preferably, about 0.05% wet strength is added to the sheet. It has been observed that the more alcohol that is present in the wetting solution, the less wet strength additive is needed. Therefore, for wipes that are wetted with solutions containing 35% or more alcohol, it is not as desirable to include a wet strength additive because it can adversely affect dispersability.

The furnish is wet-laid on a papermaking machine, such as a Fourdriner machine. The aqueous mixture is fed to a headbox and then to the fiber collecting wire thereof. The fibers are retained on the wire in a random three-dimensional configuration with slight orientation in the machine direction while the aqueous dipsersant passes through the wire and is removed. As the liquid is removed, the cellulosic fibers begin to link to one another, thereby forming a cellulosic web.

In all of the embodiments described herein, the structural integrity and strength of the cellulosic web primarily results from the mechanical and hydrogen bonding between the individual cellulosic fibers. This structural integrity can be enhanced by cross-linking some of the fibers with the above-mentioned wet strength additives. The amount of wet strength additive present in a material is directly proportional to the amount of cross-linking in the material, and directly proportional to the time required to disperse the material in large amounts of water.

In the most preferred embodiment, the substrate is creped. Creping is a procedure that includes scraping the cellulosic web from a rotatable cylinder with a creping blade. “Wet” creping is performed before the web has all of its hydrogen bonds formed, thus the creped ridges that are formed during the drying process remain intact. Creping the cellulosic web breaks some of the inter-fiber bonds of the cellulosic web, thereby increasing softness, bulkiness and absorbency, but decreasing the strength of the paper when used in a dry state. The result is a paper with a more cloth-like feel. Paper machines that perform the dry creping process, typically called “tissue” making machines, crepe the sheet as the sheet exits the “Yankee” dryer (a single can dryer). The process of creping a dried sheet to impart bulk for absorbency and stretch is inherently more detrimental to the strength of the sheet than is the wet-creping process.

Wet-creped paper is more “forgiving” than a dry-creped paper because it does not tend to spring back to an uncreped state when it is wetted with water. This characteristic is also affected by alcohol solutions; the higher the concentration of alcohol in a wetting solution, the less springing back or uncreping that occurs. Though the web may be creped when dry, in the most preferred minimum embodiment, the web is wet-creped.

After wet-creping, the wet cellulosic web is transferred to a press section and dryer section to remove most of the liquid from the web. Once it is dry, the web is either wound onto a reel or processed into wet wipe sheets. The resulting sheet has a preferred basis weight of about 40 grams per square meter or higher.

An alternative to creping is embossing. Embossing is performed after the sheet is dry, and may consist of patterns that facilitate dispersment. For example, it is known that the weakest direction of the wipe is the cross direction. The embossing pattern may be more prevalent in the cross direction than the machine direction to enhance dispersion.

In one preferred embodiment of the present invention, the substrate has a dry tensile strength of about 1500 N/m, and about 50 N/m when wetted with water. In another preferred embodiment of the present invention, the substrate has a dry tensile strength of about 1000 N/m, and about 30 N/m when wetted with a solution comprising 35% alcohol and 65% water.

In any embodiment, the web should maintain a minimum tensile strength of about 30-40 N/m if it is wetted with a solution that contains alcohol, and 40-100 N/m if it is wetted with a solution containing no alcohol. The web should also readily disperse in a solution that is at least 99% water.

Solution

Preferably, the liquid wetting solution used for cleaning is applied to the substrate after the substrate has been dried. Any variety of application methods that evenly distribute materials having a liquid consistency can be used. Suitable methods include spraying, coating (e.g. gravure coating or flood coating), and extrusion whereby the solution is forced through tubes the ends of which are in contact with the substrate whilst the substrate passes across the ends of the tubes, or combinations of these application techniques. Another example would be spraying the solution on a rotating surface, such as a calendar roll, that in turn transfers the solution to the surface of the substrate. The solution can be applied to one surface of the substrate, or preferably, both surfaces of the substrate. Alternatively, the solution can be injected or poured into a packaged portion of the dry substrate, just prior to sealing the package.

In one preferred embodiment of the present invention, the liquid solution according to the present invention is an alcohol-based solution of at least 35% alcohol, and about 65% water. In another preferred embodiment of the present invention, the solution is about 70% alcohol and about 30% water. In yet another preferred embodiment, where the web was made with up to two pounds per ton of wet strength additive (2 pounds/fiber ton), the wetting solution is largely aqueous and contains zero to about 35% alcohol.

The preferred alcohol used in the wetting solution is a two-carbon or greater alkyl alcohol. Particularly useful alcohols are ethanol, n-propanol, isopropanol, and butanol. Such alcohols have the characteristic of being anti-microbial, relatively inexpensive, and safe to handle when diluted into a water solution. Solutions containing alcohol are especially useful for cleaning hard surfaces, and even human skin.

In any of the above embodiments, additives may be added to replace part of the water. The additives may include, but are not limited to: peroxygen bleach, disinfecting components, surfactants, chelants, solvents, builders, stabilizers, bleach activators, dye transfer agents, perfumes, enzymes, dispersant, pigments, perfumes, dyes or mixtures thereof.

The dispersability of the substrate is tested in accordance with the following variation of a method, which in the toilet paper industry, is well known as the “mason jar shake test.” The following method has been adapted for the testing of wet wipes. To begin the test, a jar such as a one quart (1.1 liter) mason-type jar is filled about half-way with tap water. The water is brought to room temperature or about 25° C. (degrees Celsius). A continuous 7.6 cm×7.6 cm sheet of wet wipe material is added to the jar. The jar is then covered with a lid and shaken at a rate of approximately two (2) shakes/sec. Samples are deemed to be readily dispersable if the test sheet breaks into corn-flake size pieces within fifty (50) shakes, marginally dispersable if the sheet breaks up within 100 shakes, and non-dispersable if it takes more than 100 shakes to break up the sheet.

In a variation of the test called a “disintegration test,” standard Tappi hand sheets may be tested using the above technique. The sheets are shaken until the sheet completely disintegrates into a pulp of individual fibers. Unlike the dispersability tests, the sheets are determined to be disintegratable if the individual fibers substantially become detached from one another within 50 shakes.

Experimental Data

A. Experimental Set 1

The data presented in Table 1 shows how refining by external fibrillation positively affects tensile strength, and negatively affects dispersability. In addition, this data suggests that certain wood species or other fibers are more desirable for use as wet wipe substrates than other wood species or the like.

Handsheets made in accordance with Tappi Standards were comprised of bleached kraft pulp that was refined with a Standard PFI laboratory refiner in accordance with Tappi Standard T 248. The furnish used to make the sheets contained only fibrillated fiber and water. The sheets were dried using an Adirondack Laboratory electric dryer at 220 degrees Fahrenheit for 3 minutes.

Sheets were determined to be disintegrated or refiberized if they separated completely back into individual fibers using the disintegration test described herein, within 50 shakes. The test results shown in Table 1 indicate that longer softwood fibers are preferable when compared to shorter hardwood fibers.

TABLE 1
Effect of Refining on Tensile Strength and Disintegration
of Handsheets Made From Fiber of Various Sources

| | | | | Wet | |
|---|---|---|---|---|---|
| | Amount of | | | Tensile | |
| | Refining | | Wet | Strength- | |
| | (Number | Dry | Tensile | 42 Percent | |
| | of PFI | Tensile | Strength- | Iso- | |
| Fiber | Revo- | Strength | Water | propanol | |
| Source | lutions)** | (N/m) | (N/m) | (N/m) | Disintegratable |
| Birch | 0 | 1085 | 70 | 90 | Yes |
| Birch | 1500 | 3588 | 88 | 280 | No |
| Slash Pine | 0 | 927 | 52 | 70 | Yes |
| Slash Pine | 1500 | 1838 | 105 | 263 | Yes |
| Slash Pine | 2500 | 2870 | 140 | 315 | No |
| Northern | 0 | 1418 | 105 | 72 | Yes |
| Spruce | | | | | |
| Northern | 1500 | 3745 | 123 | 298 | Yes |
| Spruce | | | | | |
| Northern | 2500 | 4585 | 158 | 333 | Yes |
| Spruce | | | | | |
| Northern | 4000 | 5548 | 175 | 350 | No |
| Spruce | | | | | |
| Bamboo | 0 | 826 | 49 | 57 | Yes |
| Bamboo | 1500 | 2112 | 71 | 117 | Yes |
| Bamboo | 2500 | 2949 | 85 | 145 | No |
| 50/50 | 0 | 2258 | 66 | 86 | Yes |
| Blend* | | | | | |
| 50/50 | 1500 | 4638 | 87 | 178 | Yes |
| Blend* | | | | | |
| 50/50 | 2500 | 4690 | 110 | 207 | No |
| Blend* | | | | | |

*Blend of 50% Virgin Spruce and 50% recycled Paper
**PFI Mill (TAPPI Standard T 248-Laboratory Beating of Pulp)

B. Experimental Set 2

In Tables 2-6 below, the effects of a wet strength additive and creping and/or embossing on tensile strength, dispersability and absorption are shown. The seven samples tested are intended to be non-limiting examples of the wet wipe of the present invention. It is noted that the samples are referenced by number, and each number represents a batch tested. Therefore, Sample 1 in Table 1 is from the same test batch as Sample 1 of Table 6.

The “stretch” property shown below is obtained by measuring the distance between the jaws of a tensile test machine before testing a specimen, and dividing this number by the distance between the jaws just prior to specimen failure.

Sample 1 was produced using a papermaking machine having a Yankee dry creping processor (a paper machine with only one dryer typical for making creped tissues). The web was comprised of 100% Weyerhauser Grande Prairie fiber consisting primarily of bleached northern-softwood kraft that had been fibrillated using conventional disc refiners. The web was dry creped, and had a basis weight of 47 gsm. The dry creping applied during manufacturing was substantially diminished after the web was wetted with water, but retained when the web was wetted with alcohol solutions of 70% or more.

Sample 1 is readily dispersable in water yet has adequate integrity for its intended use in 100% ethanol and 70% isopropanol. The web easily breaks apart in handling when wetted with 40% isopropanol. Thus, the Sample 1 web is acceptable for use as a cleaning towelette for toilet seats and surfaces of similar texture when wetted with alcohol/water solutions having alcohol concentrations of 70% or more.

Sample 2 was produced using a papermaking machine having a wet creping processor. The web was comprised of 100% Weyerhauser Grande Prairie fiber consisting primarily of bleached northern-softwood kraft that had been fibrillated using conventional disc refiners. The web was wet creped, and had a basis weight of 41 gsm.

Sample 2 is dispersable in water yet has adequate integrity for its intended use in 100% ethanol and 40% or 70% isopropanol. Thus, the web of Sample 2 is acceptable for use as a cleaning towelette for toilet seats and surfaces of similar texture when wetted with alcohol/water solutions having alcohol concentrations of 40% or more, or other non-alchohol based solutions.

Sample 3 was produced using a papermaking machine having a wet creping processor. The web was comprised of 100% Weyerhauser Grande Prairie fiber consisting primarily of bleached northern-softwood kraft that had been fibrillated using conventional disc refiners. The web was wet creped, and had a basis weight of 73 gsm.

Sample 3 is dispersable within 20 shakes in water using the mason jar test, yet has adequate integrity for its intended use in 100% ethanol and 40 or 70% isopropanol. (It is noted that the sheet wetted with 40% alcohol did slightly tear during use.) Thus, the web of Sample 3 is acceptable for use as a cleaning towelette for toilet seats and surfaces of similar texture when wetted with alcohol/water solutions having alcohol concentrations of between 40% and 70% alcohol or more.

Sample 4 was produced using a papermaking machine having a wet creping processor. The web was comprised of 100% Weyerhauser Grande Prairie fiber consisting primarily of bleached northern-softwood kraft that had been fibrillated using conventional disc refiners. GEORGIA PACIFIC® wet strength additive (resin grade Amres 8855) was added into the furnish at a rate of 1 pound per ton of paper production (0.05% in the web). The web was wet creped, and had a basis weight of 73 gsm.

Sample 4 is dispersable within 30 shakes in water using the mason jar test, yet has adequate integrity for its intended use in 100% ethanol and 40 or 70% isopropanol. Thus, the web of Sample 4 is acceptable for use as a cleaning towelette for toilet seats and surfaces of similar texture when wetted with various liquids, including but not limited to alcohol/water solutions having alcohol concentrations of 40% alcohol or more.

Sample 5 was produced using a papermaking machine having a wet creping processor. The web was comprised of 100% Weyerhauser Grande Prairie fiber consisting primarily of bleached northern-softwood kraft that had been fibrillated using conventional disc refiners. GEORGIA PACIFIC® wet strength additive (resin grade Amres 8855) was added into the furnish a rate of 2 pound per ton of paper production (0.10% in the web). The web was wet creped, and has a basis weight of 73 gsm.

The web is dispersable within 160 shakes in water using the mason jar test, so it is not considered to be readily dispersable in conventional plumbing.

Sample 6 was produced using a papermaking machine having a wet creping processor. The web was comprised of 100% Weyerhauser Grande Prairie fiber consisting primarily of bleached northern-softwood kraft that had been fibrillated using conventional disc refiners. GEORGIA PACIFIC® wet strength additive (resin grade Amres 8855) was added into the furnish at a rate of 2 pounds per ton of paper production (0.10% in the web). The completed web was then sent to Micrex Corporation, Walpole, Mass. and dry embossed using a comb roll on an embossing machine, for example, such as a MICREX® machine, to modify the bonds within the web. The modification purposely degraded the hydrogen bonds that were developed during papermaking and imparted additional softness and absorbency. The embossing process was a double creping method; the sheet was highly creped (to about 300 to 400 percent stretch) and then fully stretched back out back to its original length.

Sample 6 absorbed 3 grams of water per dry gram of fiber before Micrexing, and 4.2 grams of water per dry gram of fiber after embossing (a 40% increase.) The web was dispersable within 70 shakes in water using the mason jar test, so it was considered to be readily dispersable in conventional plumbing. The web had adequate integrity for its intended use in 100% ethanol and 40 or 70% isopropanol. Thus, Sample 6 was acceptable for use as a cleaning towelette for toilet seats and surfaces of similar texture when wetted with liquids, including but not limited to alcohol/water solutions having alcohol concentrations of 40% alcohol or more.

Sample 7 was a commercial sample of the Ahlstrom “Dispersable Wet Wipe” Grade 8553:55, and was tested for comparative purposes. It was found to be dispersable after 40 shakes in the Mason Jar test. When fully saturated in water it had a machine direction tensile strength of 79 N/m, and a cross direction tensile strength of 31 N/m.

TABLE 2
Processing parameters for Samples 1-7

| | | Basis | | Machine |
|---|---|---|---|---|
| | | Weight | Wet | Direction |
| Sample | Process | (gsm) | Strength % | Stretch % |
| 1 | dry creped | 47 | 0 | 29 |
| 2 | wet creped | 41 | 0 | 4 |
| 3 | wet creped | 73 | 0 | 20 |
| 4 | wet creped | 73 | 0.05 | 20 |
| 5 | wet creped | 73 | 0.01 | 20 |
| 6 | wet creped and | 70 | 0.01 | 19 |
| | dry embossed | | | |
| 7 | Hydroentangled | 55 | na | 6 |
| | (Ahlstrom) | | | |

TABLE 3
Machine Direction (MD) Tensile Strength of the Samples
in Table 2, Wetted With Various Solutions

| | dry (50% | 100% | 70% iso- | 40% iso- | 10% iso- | 100% |
|---|---|---|---|---|---|---|
| Sam- | humidity) | ethanol | propanol | propanol | propanol | water |
| ple | (N/m) | (N/m) | (N/m) | (N/m) | (N/m) | (N/m) |
| 1 | 618 | 261 | 103 | 48 | 41 | 40 |
| 2 | 2160 | 871 | 225 | 127 | 74 | 71 |
| 3 | 3010 | 855 | 261 | 127 | 59 | 55 |
| 4 | 3100 | 895 | 301 | 150 | 116 | 111 |
| 5 | 3050 | 990 | 380 | 214 | 175 | 169 |
| 6 | 2151 | 800 | 253 | 142 | 122 | 120 |
| 7 | 440 | 309 | 120 | 108 | 88 | 79 |

TABLE 4
Cross Direction (CD) Tensile Strength of the Samples
in Table 2, Wetted With Various Solutions

| | dry (50% | 100% | 70% iso- | 40% iso- | 10% iso- | 100% |
|---|---|---|---|---|---|---|
| Sam- | humidity) | ethanol | propanol | propanol | propanol | water |
| ple | (N/m) | (N/m) | (N/m) | (N/m) | (N/m) | (N/m) |
| 1 | 222 | 103 | 32 | 17 | 8 | 8 |
| 2 | 1526 | 515 | 166 | 103 | 63 | 60 |
| 3 | 1740 | 618 | 198 | 71 | 36 | 30 |
| 4 | 1750 | 602 | 214 | 95 | 52 | 41 |
| 5 | 1722 | 610 | 246 | 135 | 106 | 105 |
| 6 | 1148 | 578 | 198 | 96 | 74 | 69 |
| 7 | 190 | 119 | 59 | 39 | 31 | 31 |

TABLE 5
Absorbency of Samples in Table 2.

| | Absorbency | Absorbency |
|---|---|---|
| | (g/g) | (g/g) |
| Sample | 100% ethanol | 100% water |
| 1 | 2.1 | 3.8 |
| 2 | 1.5 | 3.2 |
| 3 | 1.6 | 30 |
| 4 | 1.6 | 3.4 |
| 5 | 1.6 | 3.0 |
| 6 | 2.0 | 69 |
| 7 | 4.1 | 31 |

TABLE 6
Dispersability of Samples in Table 2 as
Compared to CD Tensile Strength

| | CD Tensile | CD Tensile | |
|---|---|---|---|
| | Strength | Strength | |
| | (N/m) | (N/m) | |
| | dry (50% | 100% | Dispersability |
| Sample | humidity) | water | (number of shakes) |
| 1 | 222 | 8 | 20 |
| 2 | 1526 | 60 | 80 |
| 3 | 1740 | 30 | 20 |
| 4 | 1750 | 41 | 30 |
| 5 | 1722 | 105 | 160 |
| 6 | 1148 | 69 | 70 |
| 7 | 190 | 31 | 40 |

The test results shown in the above tables indicate that higher percentages of alcohol in the wetting solution results in higher strength values. Likewise, higher amounts of a wet strength additive (such as polyamide) results in higher tensile strength values. The number of shakes needed to cause the samples to disperse the samples may indicate which webs are optimal for cleaning and dispersing.

1. A pre-moistened wet wipe comprising:
a paper substrate comprising substantially all fibrillated cellulosic fibers; and
a wetting solution;
wherein the substrate, when wetted with the wetting solution, has a tensile strength no less than 20 Newtons/meter, and is dispersable within 100 shakes when tested using a mason jar shake test.

2. The wet wipe of claim 1 wherein the wetting solution contains alcohol selected from the group consisting of ethanol, n-propanol, isopropanol and butanol.

3. The wet wipe of claim 2 wherein the wetting solution contains less than 35% alcohol and further includes up to 2 pounds per fiber ton of a wet strength additive.

4. The wet wipe of claim 2 wherein the substrate has a basis weight of 30 to 150 gsm.

5. The wet wipe of claim 4 wherein the substrate has a basis weight of 40 to 100 gsm.

6. The wet wipe of claim 1 wherein the tensile strength is 40 to 100 Newtons/meter in its weakest planar direction.

7. The wet wipe of claim 1 wherein the tensile strength is 30 to 70 Newtons/meter in its weakest planar direction.

8. The wet wipe of claim 1 wherein the wetting solution contains 20 percent to 100 percent alcohol.

9. The wet wipe of claim 1 wherein the wetting solution contains 40 percent to 80 percent alcohol.

10. The wet wipe of claim 1 wherein the cellulosic fiber comprises wood fibers.

11. The wet wipe of claim 10 wherein the cellulosic fiber is comprised of, at least in part, softwood fibers.

12. The wet wipe of claim 10 wherein the substrate is embossed.

13. The wet wipe of claim 10 wherein the substrate is creped.

14. A pre-moistened wet wipe comprising:
a paper substrate having a basis weight of 30 to 150 gsm and comprised of fibrillated wood fiber and up to 2 pounds per fiber ton of a wet strength additive; and
a wetting solution comprising of water and 35 percent to 70 percent alcohol;
wherein the wet wipe is dispersable when immersed and agitated in a solution of at least 99 percent water.

15. The wet wipe of claim 14 wherein the wet wipe is dispersable in accordance with a mason jar shake test.

16. The wet wipe of claim 14 wherein the alcohol is selected from the group consisting of ethanol, n-propanol, isopropanol and butanol.

17. The wet wipe of claim 14 wherein the cellulosic fiber is selected from the group consisting of bleached northern spruce fiber, douglas fir, lodgepole pine, western larch, white pine, cedar, Grand fir, western hemlock, ponderosa pine, redwood, balsam, jack pine, red pine, loblolly pine, slash pine, Virginia pine, and long leaf pine.

18. The wet wipe of claim 14 wherein the cellulosic fiber is selected from the group consisting of bamboo, kenaf, hemp, and bagasse.

19. The wet wipe of claim 14 wherein the substrate was wet-creped during manufacture.

20. The wet wipe of claim 18 wherein the substrate is embossed.

21. A method of manufacturing a wet wipe of claim 1 comprising the steps of:
fibrillating cellulosic fibers;
making a paper web from the cellulosic fibers;
drying the paper web to form a paper substrate, wherein the resulting paper substrate has a basis weight of 30 to 150 gms; and
applying a wetting solution to the paper substrate.

22. The method of claim 21 further including the step of adding a wet strength additive to the cellulosic fibers before the step of making the paper web.

23. The method of claim 21 further including the step of creping the paper web.

24. A wet wipe produced according to the method of claim 21.

25. The wet wipe of claim 21, wherein the wet wipe is placed into a package.

26. The method of claim 21 wherein the substrate is embossed.

27. A dispersable wet wipe comprising:
a paper substrate having a basis weight of 40 gsm to 75 gsm and a dry cross-direction tensile strength of at least 1000 N/m; and
a wetting solution comprising of 35 percent to 70 percent alcohol;
wherein the wet wipe has tensile strength of at least 30 N/m when wetted with the wetting solution and is dispersable when agitated in a solution of at least 99 percent water.

28. A dispersable wet wipe comprising:
a paper substrate having a basis weight of 40 gsm to 75 gsm and a dry tensile strength in its weakest planar direction of at least 200 N/m; and
a wetting solution comprising of 70 percent to 100 percent alcohol;
wherein the wet wipe has a wet tensile strength in the weakest planar direction of at least 30 N/m when wetted in 70% to 100% alcohol, and is dispersable when agitated in a solution of at least 99% water.

29. A method of cleaning a toilet seat in a public bathroom comprising:
mounting a dispenser in a bathroom;
removing a wet wipe in accordance with claim 1 from the dispenser;
applying the wet wipe to the toilet seat;
wiping the toilet seat with the wet wipe; and
disposing of the wet wipe in a toilet bowl attached to the toilet seat.

30. A pre-moistened wet wipe comprising:
a paper substrate comprising fibrillated cellulosic fibers; and
a wetting solution;
wherein the substrate, when wetted with the wetting solution, has a tensile strength no less than 40 Newtons/meter, and is dispersable within 100 shakes when tested using a mason jar shake test.
